(19) United States
(12) Patent Application Publication
(10) Pub. No.: US 2018/0082476 A1
(43) Pub. Date: Mar. 22, 2018

(54) COLLABORATIVE SEARCH FOR OUT OF FIELD OF VIEW AUGMENTED REALITY OBJECTS

(71) Applicant: International Business Machines Corporation, Armonk, NY (US)

(72) Inventors: Eric V. Kline, Rochester, MN (US); Sarbajit K. Rakshit, Kolkata (IN)

(21) Appl. No.: 15/272,605

(22) Filed: Sep. 22, 2016

(51) Int. Cl. G06T 19/00; G09G 5/00; G06T 7/00; G06T 7/60; G06K 9/62

(52) U.S. Cl. CPC G06T 19/006; G09G 5/003; G06K 9/6267; G06T 7/60; G06T 7/004

(57) ABSTRACT

A method includes receiving, by a first augmented reality device associated with a first user and from a second augmented reality device associated with a second user, identification of an object within a field of view of the second augmented reality device, wherein the object is outside a field of view of the first augmented device. The method includes displaying, on a display of the first augmented device, an identifier of the object.

### BACKGROUND

Embodiments of the inventive subject matter generally relate to computing devices, and more particularly, augmented reality devices.

Augmented reality devices can include head mounted devices (e.g., glasses) and handheld devices (e.g., smartphones). Augmented reality devices can identify objects in their field of view. Augmented reality devices can also display information on their displays about the identified objects. For example, augmented devices can identify a famous monument, rare animal, etc. and some relevant facts about the objects.

### SUMMARY

In some embodiments, a method includes receiving, by a first augmented reality device associated with a first user and from a second augmented reality device associated with a second user, identification of an object within a field of view of the second augmented reality device, wherein the object is outside a field of view of the first augmented device. The method includes displaying, on a display of the first augmented device, an identifier of the object. In other embodiments, a computer program product and apparatus implement the method described above.

### BRIEF DESCRIPTION OF THE DRAWINGS

The present embodiments may be better understood, and numerous objects, features, and advantages made apparent to those skilled in the art by referencing the accompanying drawings.

FIG. 1 depicts an example of a collaborative search for objects using augmented reality devices, according to some embodiments.

FIG. 2 depicts a typical augmented reality device, according to some embodiments.

FIG. 3 depicts a flowchart of operations for detection and notification of out of field of view objects in a collaborative group, according to some embodiments.

FIG. 4 depicts a flowchart of operations for displaying identification of objects out of field of view of the augmented reality device, according to some embodiments.

FIG. 5 depicts a computer system, according to some embodiments.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, although examples depict augmented reality devices as head mounted devices, augmented reality devices can include other types of devices, such as smartphones, tablets, etc. In other instances, well-known instruction instances, protocols, structures and techniques have not been shown in detail in order not to obfuscate the description.

Some embodiments include a collaborative search for objects that are beyond a field of view of an augmented reality device. A group of users can be part of the collaborative search. Each user within the group can be associated with an augmented reality device. For example, each user can use a head mounted device. The group of users can be part of a group activity (e.g., a safari). One or more of the users can specify one or more objects to be located using the augmented reality devices. For example, assume the group of users plan to go on a safari to see wild animals in their natural habitat. The user can specify which animals they want to see. For example, the users can specify by uploading a photograph, providing the name of the object, providing a certain pattern, etc. The users can perform this specification of objects to be located prior to their group activity. The different users are using the head mounted devices. Thus, if any specified animal enters the field of view of the head mounted device, the head mounted device can communicate with the head mounted devices of the other users in the group. The head mounted devices of the other users can highlight this object on their display even though the object is currently not in their field of view. The head mounted devices of the other users can also provide a direction so that the other users can view the object through their head mounted devices. Accordingly, some embodiments allow for the collaborative search of dynamic (non-static) objects that can change locations over time.

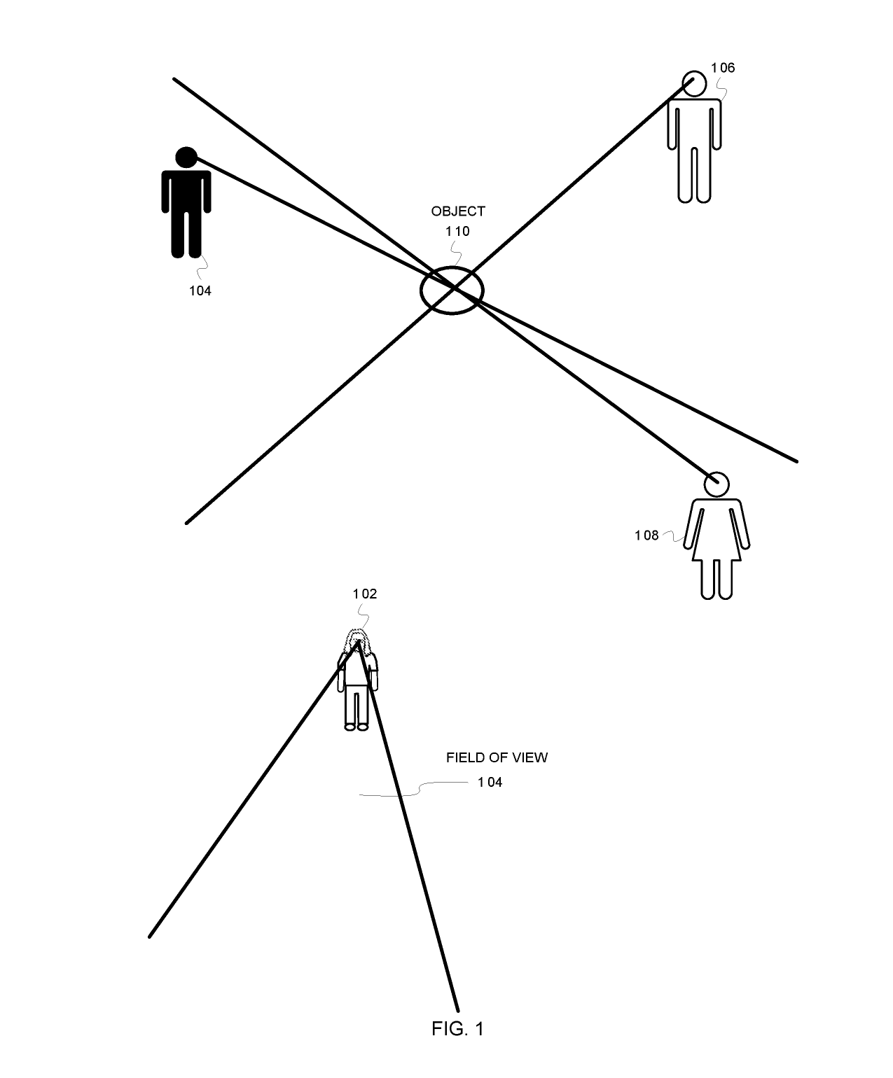

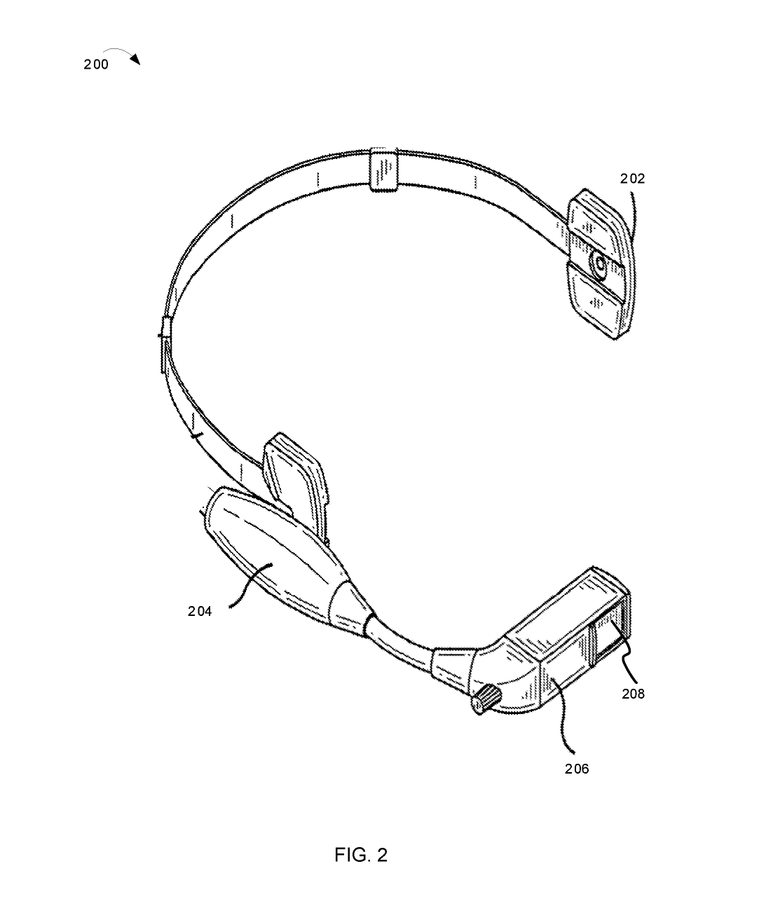

FIG. 1 depicts an example of a collaborative search for objects using augmented reality devices, according to some embodiments. FIG. 1 depicts a number of users that can be part of a collaborative group for sharing images among each other that were captured using augmented reality devices. The number of users includes a user 102, a user 104, a user 108, and a user 108. Although not shown, each of the users can be using an augmented reality device (e.g., a head mounted device). An example of an augmented reality device is depicted in FIG. 2, which is described in more detail below. The users 102-108 can be part of a group activity. For example, the users can be part of a safari expedition in which they are attempting to see different wildlife in the natural habitat.

As further described below, one or more objects that the user wants to see can be identified by the users prior to starting the group activity. For example, one or more users can upload a photograph of an object to be located during a collaborative search activity. The one or more users can upload the photograph to a backend server that communicates with each of the augmented reality devices of the users within the group. Alternatively or in addition, the user can provide a description of the object to the backend server or augmented reality device. For example, the user can indicate that the users want to view a tiger hunting. The user could also just provide the name of the object (e.g., an elephant).

In this example, the user 104, the user 106, and the user 108 view an object 110 using their augmented reality devices. In other words, the object 110 is within the field of view of the augmented reality devices for the user 104, the user 106, and the user 108. However, the object 110 is not within a field of view 104 of the augmented reality device for the user 102.

The augmented reality devices for the user 104, the user 106, and the user 108 can wirelessly communicate with the augmented reality device for the user 102. The communication can be a peer-to-peer communication, communication via a backend server, etc. The communication can include an identification of the object 110 along with its location. As further described below, the identification and optionally its location can be displayed over the lenses of the augmented reality device for the user 102. The user 102 then has the option of moving to allow the user 102 to view the object 110.

FIG. 2 depicts a typical augmented reality device, according to some embodiments. In this example, the augmented reality device 200 includes a head mounted device that includes a lens 208. The lens can be see-through while allowing for images to be displayed thereon. For example, a projection of images can be overlaid such that a user can see their field of view with images overlaid thereon.

The augmented reality device 200 also includes an optics module 206 that include one or more sensors. For example, the optics module 206 can include one or more image sensors that can be configured to capture images of what the user is seeing through the lens 208. The optics module 206 can also include one or more eye sensors. The eye sensors can capture images of the user's eye. These images can include images of the pupils of the eye. Thus, this images of the pupil can help determine a direction the user is looking through the augmented reality device 200.

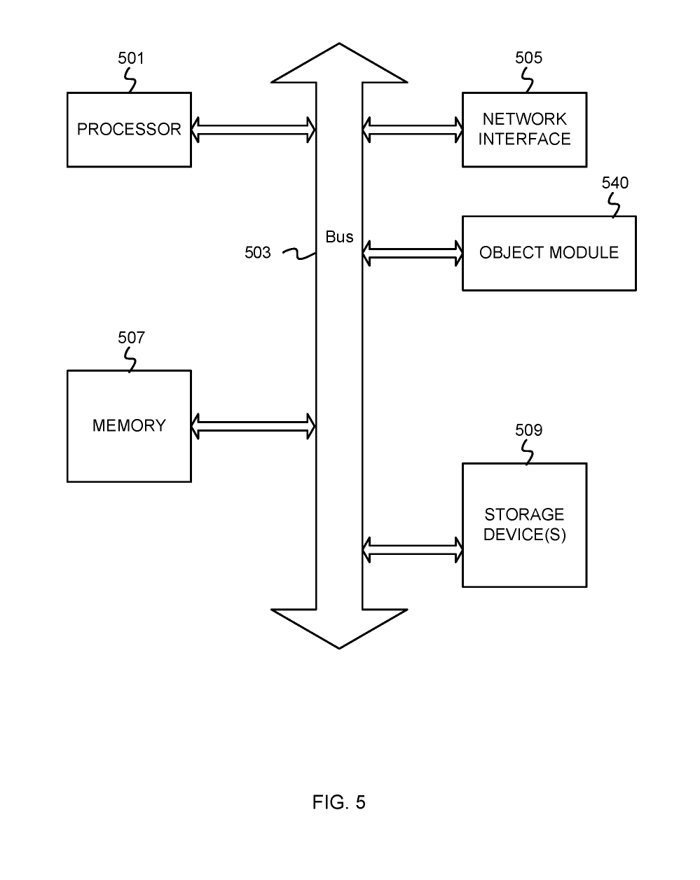

The augmented reality device 200 also includes a computing device 204. The computing device 204 is communicatively coupled to the lens 208 and the optics module 206. The computing device 204 can include one or more processors for executing instructions for controlling and capturing data from the various components (e.g., the image sensors) of the augmented reality device 200. The one or more processors can also execute instructions to determine a position of the augmented reality device 200 (e.g., Global Position System (GPS)-based positioning). The computing device 204 may also include hardware and/or software to communicate with computing devices in other augmented reality devices (as further described below). The computing device 204 can also include different types of storage (e.g., memory, nonvolatile storage, etc.). An example of the computing device 204 is depicted in FIG. 5, which is described in more detail below. The augmented reality device 200 can include additional and/or alternative components (e.g., sensors, cameras, etc.).

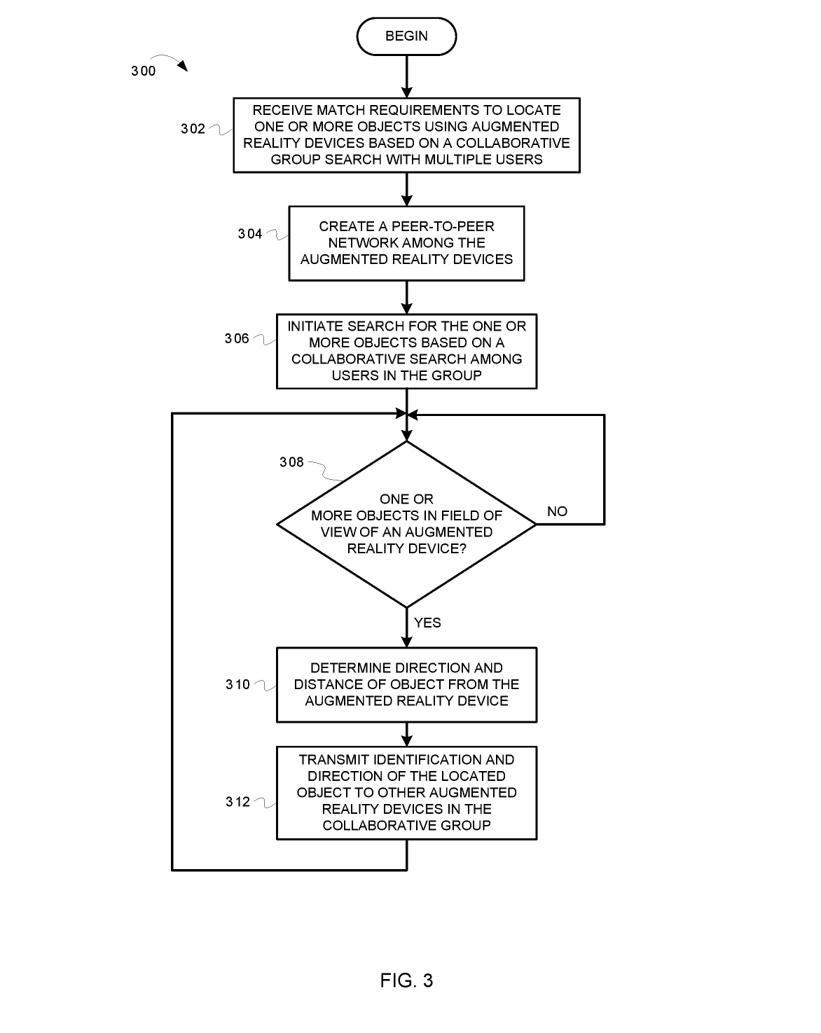

FIG. 3 depicts a flowchart of operations for detection and notification of out of field of view objects in a collaborative group, according to some embodiments. A flowchart 300 of FIG. 3 is described in reference to FIGS. 1-2 and 5. The operations of the flowchart 300 can be performed by software, firmware, hardware or a combination thereof. For the flowchart 300, the operations are described as being performed by an object module. The object module can be instructions executable by one or more processors. An example of the object module is depicted in FIG. 5 (which is described in more detail below). As described herein, the object module is executable in a computing device that is part of an augmented reality device. In some other embodiments, some or all of the operations depicted in FIG. 3 can be performed by a backend server that is communicatively coupled to the augmented reality device. The operations of a flowchart 300 start at block 302.

At block 302, the object module receives match requirements to locate one or more objects using augmented reality devices on a collaborative search with multiple users. For example, one or more users can upload a photograph of an object to be located during a collaborative search activity. The one or more users can upload the photograph to a backend server that communicates with each of the augmented reality devices of the users within the group. Alternatively or in addition, the one or more users can upload the photograph to their augmented reality device. In turn, the augmented reality device that receives the photograph can transmit the photograph to the other augmented reality devices defined as being in the group. For example, assume that the group of users are going on a safari. A user can upload a photograph of a bird or animal that the users want to see while on the safari. Alternatively or in addition, the user can provide a description of the object to the backend server or augmented reality device. For example, the user can indicate that the users want to view a tiger hunting. The user could also just provide the name of the object (e.g., an elephant). Operations of the flowchart 300 continue at block 304.

At block 304, the object module creates a peer-to-peer (P2P) network among the augmented reality devices in the group. For example, the object module in an augmented reality device can establish the P2P network by establishing wireless communications with object modules in each of the other augmented reality devices assigned to the group. To illustrate, the users can input into their augmented reality device the network address or identifier of the other augmented reality devices assigned to the group. The object modules can then establish a network of communications among each other based on the network addresses or identifiers of the augmented reality devices assigned to the group. In another embodiment, the object module can use an existing network (such as a client-server network) for communication among the augmented reality devices in the group. In yet another embodiment, the object module can create and/or use a hybrid network for communication among the augmented reality devices in the group. Operations of the flowchart 300 continue at block 306.

At block 306, the object module initiates search for the one or more objects based on a collaborative search among the users in the group. For example, the users can input a request into the augmented reality device to start the search once the group activity has commenced (e.g., started on their safari). In some embodiments, the augmented reality devices can include GPS modules to determine their locations. Thus, the object module can initiate a search after the augmented reality device is within a defined area for the group activity. Operations of the flowchart 300 continue at block 308.

At block 308, the object module determines whether one or more objects are in the field of view of its augmented reality device. The object module can capture frames of what the user is viewing through the lens and then determine if there are matches between objects in the frame and objects that the users have input to be located during their group activity. For example, if the object to be located is a tiger, the object module can compare an image of a tiger to the objects in the frame. As an example, the object module can compare the object in the photograph uploaded by the users with objects in the frame. If the object to be located is just a text-based input, an image of that object can be downloaded from a backend server to the augmented reality device prior to the group activity. Alternatively, the object module can upload the frames to the backend server. A module on the backend server could then determine if there are matches between the objects in the frames and the objects to be located. If no objects are in the field of view of the augmented reality device, operations remain at block 308. If one or more objects are in the field of view of the augmented reality device, operations continue at block 310.

At block 310, the object module determines direction of the object in the field of view from the augmented reality device. In some embodiments, the object module can determine a direction that the lens of the augmented reality device is facing. For example, the augmented reality device can include a device to determine direction (e.g., compass, gyroscope, etc.). To illustrate, the augmented reality device can include a virtual compass (or clock). The virtual compass/clock can be synchronized to a selected user or reference point and directions to an object of interest are given to each other user based on that user's relative position/attitude with regard to the absolute or relative reference point (e.g., a specific user's augmented reality device could direct the user to “289 degrees” or “10 o'clock”, relative to their own position, to see a zebra, etc.). Operations continue at block 312.

At block 312, the object module transmits identification and direction of the located object to other augmented reality devices in the collaborative group. For example, the object module can transmit a wireless communication to the other augmented reality devices that are considered part of the group using the P2P network (see description of block 304 above). Operations return to block 308 to determine if other objects are in the field of view of the augmented reality device. The operations of the flowchart 300 can continue until the user inputs a request to cease the operations. The operations of the flowchart 300 can stop based on other operations. For example, the operations of the flowchart 300 can also be set to stop after a defined period of time. The operations can also stop if the augmented reality device is moved beyond defined boundaries. For example, if the augmented reality device is moved outside the boundaries that define an activity, the operations can stop. As an example, if the activity is a safari, the boundaries can be defined for the safari. If the augmented reality device is moved beyond the boundaries of the safari, the operations can be stopped.

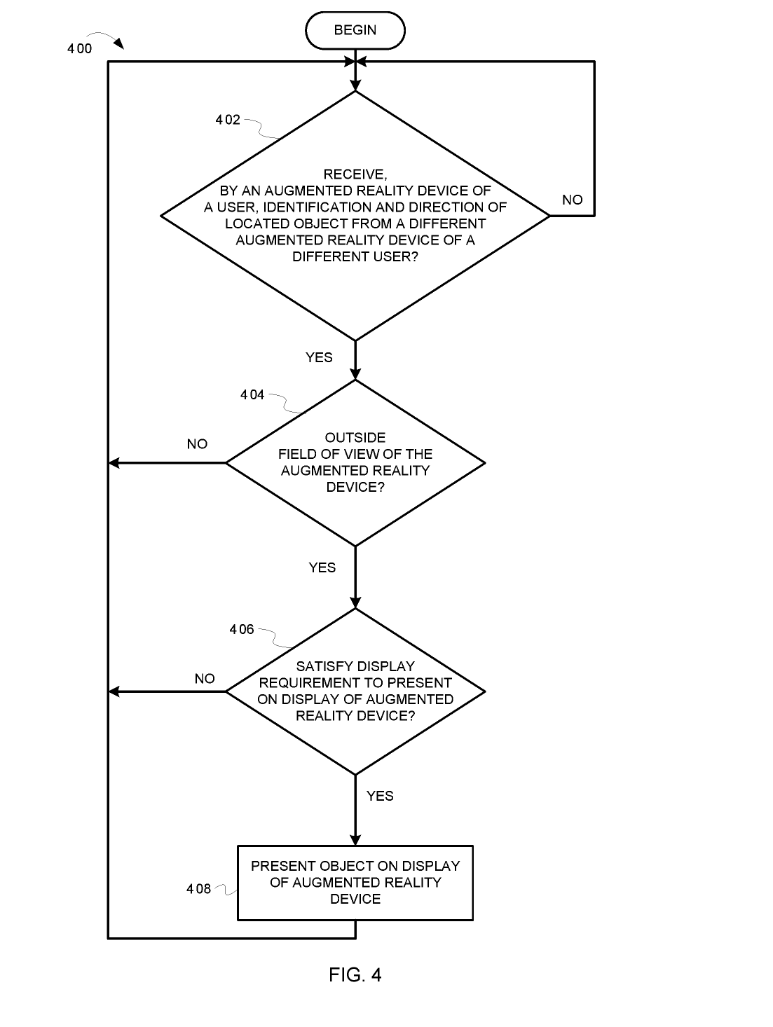

FIG. 4 depicts a flowchart of operations for displaying identification of objects out of field of view of the augmented reality device, according to some embodiments. A flowchart 400 of FIG. 4 is described in reference to FIGS. 1-2 and 5. The operations of the flowchart 400 can be performed by software, firmware, hardware or a combination thereof. For the flowchart 400, the operations are described as being performed by an object module. The object module can be instructions executable by one or more processors. An example of the object module is depicted in FIG. 5 (which is described in more detail below). As described herein, the object module is executable in a computing device that is part of an augmented reality device. In some other embodiments, some or all of the operations depicted in FIG. 4 can be performed by a backend server that is communicatively coupled to the augmented reality device. The operations of the flowchart 400 can be performed at least partially in parallel with the operations of the flowchart 300. For example, the operations of the flowchart 400 can be performed by one thread of a process, while the operations of the flowchart 300 can be performed by a different thread of the process. The operations of the flowchart 400 can be initiated in response to users inputting a request into the augmented reality device to start the search once the group activity has commenced (e.g., started on their safari) (as described above in reference to FIG. 3). The operations of a flowchart 400 start at block 402.

At block 402, the object module determines whether identification and direction of a located objected is received from a different augmented device of a different user in the collaborative group. For example as described at block 312 of FIG. 3 above, an object module transmits identification and direction of the located object to other augmented reality devices in the collaborative group after the object is located in its field of view. The operations here at block 402 are described from the perspective of the object modules in the other augmented reality devices in the collaborative group that receive the identification and direction of the located object. If no identification and direction of an object are received from other augmented reality devices, operations remain at block 402. If identification and direction of an object is received, operations continue at block 404.

At block 404, the object module determines whether the object is outside the field of view of the augmented reality device that received the identification and direction of the object. With reference to FIG. 1, assume that the augmented reality device for the user 102 receives the identification and direction of the object 110 from the augmented reality device for the user 102. In this example, the object 110 is outside the field of view of the augmented reality device for the user 102. In a different example with reference to FIG. 1, assume that the augmented reality device for the user 108 receives the identification and direction of the object 110 from the augmented reality device for the user 102. In this example, the object 110 is inside the field of view of the augmented reality device for the user 108. If the object is not outside the field of view of view of the augmented reality device that received the identification and direction of the object, operations of the flowchart 400 return to block 402. If the object is outside the field of view of view of the augmented reality device that received the identification and direction of the object, operations of the flowchart 400 continue at block 406.

At block 406, the object module determines whether the object satisfies a display requirement to present the object on a display of the augmented display device. In some embodiments, the display requirement may be that more than one other user identified the object through their augmented reality devices. Thus, the object module would need to receive identification and direction of the same object from two or more other users in the group. With reference to FIG. 1, the augmented reality device for the user 102 would need to receive identification and direction of the object 110 from at least two of the users 104, 106, and 108 in order to satisfy the display requirement. In some embodiments, the display requirement may be that the majority of the other users need to provide identification of the object through their augmented reality devices to satisfy the display requirement. In some embodiments, the display requirement may be related to how far the object is from the augmented reality device. With reference to FIG. 1, if the user 102 is more than a defined distance from the object 110, the display requirement is not satisfied. In some embodiments, the display requirement may be related to how fast the object is moving. For example, if the object is moving greater than a defined speed, the display requirement is not satisfied. The example display requirements described above can be combined in different variations. For example, the display requirement for the number of users who have the object in their field of view can be combined with the display requirement for how far the user is from the object. In some embodiments, the display requirement can include a hierarchy of interest in the objects. For example, the hierarchy can include highly important, important, interested, lower level of interest, etc. This hierarchy of interest can be combined with other display requirements. For example, if the user that is to view the object on the display of their augmented reality device defines the object as being highly important, the object would be displayed if only one other user would need to identify the object in their field of view and there would be no distance requirement. In another example, if the user that is to view the object on the display of their augmented reality device defines the object as being lower level of interest, the object would be displayed if a majority of users identified the object in their field of view and the object is within a defined distance of the user. In some embodiments, there is no display requirement. If the display requirement is not satisfied, operations of the flowchart 400 return to block 402. If the display requirement is satisfied, operations of the flowchart 400 continue at block 408.

At block 408, the object module presents object on display of augmented reality device. For example, the object module can present an icon representing the object in a corner of the display. The object module can also display a location and direction of the object relative to the augmented reality device. This can allow the user of the augmented reality device to move to a location such that the user can view the object within its field of view using their augmented reality device.

Similar to the operations of the flowchart 300, the operations of the flowchart 400 can continue until the user inputs a request to cease the operations. The operations of the flowchart 400 can stop based on other operations. For example, the operations of the flowchart 400 can also be set to stop after a defined period of time. The operations can also stop if the augmented reality device is moved beyond defined boundaries. For example, if the augmented reality device is moved outside the boundaries that define an activity, the operations can stop. As an example, if the activity is a safari, the boundaries can be defined for the safari. If the augmented reality device is moved beyond the boundaries of the safari, the operations can be stopped.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 5 depicts a computer system, according to some embodiments. A computer system includes a processor 501 (possibly including multiple processors, multiple cores, multiple nodes, and/or implementing multi-threading, etc.). The computer system includes a memory 507. The memory 507 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 503 (e.g., PCI, ISA, PCI-Express, HyperTransport®, InfiniBand®, NuBus, etc.), a network interface 505 (e.g., an ATM interface, an Ethernet interface, a Frame Relay interface, SONET interface, wireless interface, etc.), and a storage device(s) 509 (e.g., optical storage, magnetic storage, etc.). The computer system also includes an object module 540 to creating and updating of the diagrams, as described herein. Some or all of the operations of the object module 540 may be implemented with code embodied in the memory and/or processor, co-processors, other cards, etc. Any one of these operations may be partially (or entirely) implemented in hardware and/or on the processor 501. For example, the operations may be implemented with an application specific integrated circuit, in logic implemented in the processor 501, in a co-processor on a peripheral device or card, etc.

Further, realizations may include fewer or additional components not illustrated in FIG. 5 (e.g., audio cards, additional network interfaces, peripheral devices, etc.). The processor 501, the storage device(s) 509, the network interface 505, the memory 507, and the object module 540 are coupled to the bus 903. Although illustrated as being coupled to the bus 503, the memory 507 may be coupled to the processor 501.

While the embodiments are described with reference to various implementations and exploitations, it will be understood that these embodiments are illustrative and that the scope of the inventive subject matter is not limited to them. In general, techniques for collaborative search for out of field of view augmented reality objects as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
receiving, by a first augmented reality device associated with a first user and from a second augmented reality device associated with a second user, identification of an object within a field of view of the second augmented reality device, wherein the object is outside a field of view of the first augmented device; and
displaying, on a display of the first augmented device, an identifier of the object.

2. The method of claim 1, wherein the object comprises a non-stationary, dynamic object.

3. The method of claim 1, further comprising:
determining, using a positioning device, a direction of the object from the first augmented device; and
displaying, on the display of the first augmented device, the direction of the object.

4. The method of claim 1, further comprising:
determining a distance between the first augmented reality device and the object; and
displaying, on the display of the first augmented device, the distance.

5. The method of claim 1, further comprising:
receiving a search requirement from at least one of the first user and the second user that defines the object.

6. The method of claim 5, wherein receiving the search requirement comprises receiving an uploaded image of the object.

7. The method of claim 1, wherein the displaying occurs after a display requirement is satisfied, wherein the display requirement comprises receiving, from a third augmented reality device associated with a third user, the identification of the object within the field of view of the third augmented reality device.

8. A computer program product for displaying an object, the computer program product comprising:
a computer readable storage medium having computer usable program code embodied therewith, the computer usable program code comprising a computer usable program code configured to:
receive, by a first augmented reality device associated with a first user and from a second augmented reality device associated with a second user, identification of the object within a field of view of the second augmented reality device, wherein the object is outside a field of view of the first augmented device; and
display, on a display of the first augmented device, an identifier of the object.

9. The computer program product of claim 8, wherein the object comprises a non-stationary, dynamic object.

10. The computer program product of claim 8, wherein the computer usable program code is configured to:
determine, using a positioning device, a direction of the object from the first augmented device; and
display, on the display of the first augmented device, the direction of the object.

11. The computer program product of claim 8, wherein the computer usable program code is configured to:
determine a distance between the first augmented reality device and the object; and
display, on the display of the first augmented device, the distance.

12. The computer program product of claim 8, wherein the computer usable program code is configured to:
receive a search requirement from at least one of the first user and the second user that defines the object.

13. The computer program product of claim 11, wherein the computer usable program code configured to receive the search requirement comprises computer usable program code configured to receive an uploaded image of the object.

14. The computer program product of claim 8, wherein the computer usable program code configured to display occurs after a display requirement is satisfied, wherein the display requirement comprises receipt, from a third augmented reality device associated with a third user, the identification of the object within the field of view of the third augmented reality device.

15. A first augmented reality device comprising:
a display;
a processor communicatively coupled to the display; and
a computer readable storage medium having program instructions embodied therewith, the program instructions executable by the processor to cause the first augmented reality device to,
receive, by the first augmented reality device associated with a first user and from a second augmented reality device associated with a second user, identification of the object within a field of view of the second augmented reality device, wherein the object is outside a field of view of the first augmented device; and
display, on the display of the first augmented device, an identifier of the object.

16. The first augmented reality device of claim 15, wherein the object comprises a non-stationary, dynamic object.

17. The first augmented reality device of claim 15, wherein the program instructions comprises program instructions executable by the processor to cause the first augmented reality device to:
determine, using a positioning device, a direction of the object from the first augmented device; and
display, on the display of the first augmented device, the direction of the object.

18. The first augmented reality device of claim 15, wherein the program instructions comprises program instructions executable by the processor to cause the first augmented reality device to:
determine a distance between the first augmented reality device and the object; and
display, on the display of the first augmented device, the distance.

19. The first augmented reality device of claim 15, wherein the program instructions comprises program instructions executable by the processor to cause the first augmented reality device to:
receive a search requirement from at least one of the first user and the second user that defines the object.

20. The first augmented reality device of claim 15, wherein the program instructions executable by the processor to cause the first augmented reality device to display occurs after a display requirement is satisfied, wherein the display requirement comprises receipt, from a third augmented reality device associated with a third user, the identification of the object within the field of view of the third augmented reality device.
